(19) United States
(12) Patent Application Publication
(10) Pub. No.: US 2004/0232630 A1
(43) Pub. Date: Nov. 25, 2004

(54) Convoluted boot

(76) Inventor: Lothar Gasper, Lohmar (DE)

Correspondence Address: Robert P. Renke, Suite 250, 28333 Telegraph Road, Southfield, MI, 48034, US

(21) Appl. No.: 10/811,264

(22) Filed: Mar. 26, 2004

(30) Foreign Application Priority Data
Mar. 27, 2003 (DE) 103 13 696.7

(51) Int. Cl. F16J 15/52

(52) U.S. Cl. 277/635

(57) ABSTRACT

A convoluted boot for sealing an annular chamber filled with a lubricant between an outer joint part of a universal joint and a shaft connected to an inner joint part of a universal joint. The convoluted boot includes a first collar (2) to be fixed to the shaft, a second collar (3) to be fixed to an outer part of a universal joint as well as a boot portion (4) with a plurality of annular folds, which boot portion connects the two collars. Each of the annular folds (5) has a first annular flank facing the first collar (2) and a second annular flank facing the second collar (3), wherein the surface of at least one of the two annular flanks of at least one of the annular folds (5) comprises a plurality of raised portions which project from a uniform annular face or a plurality of recesses.

### TECHNICAL FIELD

The invention relates to a convoluted boot made of an elastic material for sealing an annular joint chamber filled with a lubricant such as between an outer joint part of a universal joint and a shaft connected to the inner joint part of a universal joint.

### BACKGROUND OF THE INVENTION

The purpose of convoluted boots is to cover joint chambers and thus prevent lubricant from escaping and dirt from entering. Convoluted boots are frequently used in constant velocity universal joints in motor vehicle drivelines.

In the case of large articulation angles of universal joints, the annular folds of the convoluted boots which are also articulated are greatly deformed, with the outer surfaces of adjoining annular folds touching one another. The relative movements of outer surfaces contacting one another, especially under wet rainy conditions, leads to the development of noise which is experienced as being unpleasant and contravenes today's requirements regarding vehicle comfort. The noise is generated as a result of adhesion forces between the annular flanks contacting one another when there exists a water film with a thickness in the micro or nano range (stick slip effects).

From U.S. Pat. No. 6,569,021, there is known a convoluted boot consisting of a thermoplastic or elastic material which is impregnated. By impregnating the convoluted boot, there is provided a reservoir of lubricant for the outer surface, so that both the noise level and the rate of wear are reduced. However, this method provides only short-term protection from the development of undesirable noise because, after some time, the impregnating agent is washed off or worn off.

DE 43 01 062 C1 proposes a convoluted boot comprising a coating which can easily be applied and which reduces the rubbing effect between the annular folds. With this embodiment, too, it is disadvantageous that the coating is washed off after some time, so that there is no long-term protection against the development of noise and wear.

U.S. Pat. No. 4,597,745 shows an elastic convoluted boot for protecting a constant velocity joint. It comprises a rigid portion in the shape of a spherical segment whose wall thickness decreases from the connection to the shaft towards the outer joint part. The outer face of said portion is provided with continuous grooves or burls to prevent crack propagation from developing further. The outer face of the rigid portion does not come into contact with other portions of the convoluted boot.

From EP 0 620 398 B1 there is known a sliding ring seal with a rubber boot which acts as the carrier of a sliding ring rotating with a shaft. The rubber boot is slipped on to the shaft and comprises a corrugated portion, with partial regions of said corrugated portion coming into contact with one another. In order to prevent said partial regions from adhering to one another permanently, the inside of the corrugated portion is provided with burls which project inwardly from an inner surface of the partial regions.

### SUMMARY OF THE INVENTION

The present invention provides a convoluted boot which achieves a reduction in the development of noise when rotating in an articulated condition, more particularly under wet rainy conditions.

In accordance with the invention, a convoluted boot is provided which comprises an elastic material and which serves to seal an annular chamber filled with lubricant between an outer joint part and a shaft connected to an inner joint part of a universal joint. The convoluted boot comprises a first collar to be fixed to the shaft and a second collar to be fixed to an outer part of a universal joint as well as a boot portion with a plurality of annular folds, which boot portion connects the two collars, wherein each of the annular folds comprises a first annular flank facing the first collar and a second annular flank facing the second collar. The surface of at least one of the two annular flanks of at least one of the annular folds comprises a plurality of raised portions which project from a uniform annular face.

Such a convoluted boot is advantageous, especially under wet rainy conditions, in that the development of noise in the articulated joint is minimized. In the present convoluted boot, the opposed annular flanks of two adjoining annular folds are held at a distance from one another by the raised portions projecting from the uniform annular face. A uniform annular face is meant to be a conical or convex or concave annular rotational face from which the raised portions project locally. When the universal joint rotates, the annular flanks do not rub against one another in a planar way because there is only point-contact at the raised portions. In this way, the adhesion forces effective as a result of the water film between the annular flanks are reduced, so that the development of unpleasant noise is prevented. Furthermore, because the annular flanks are no longer in surface contact with one another, the good lubricating characteristics of water existing in the form of a film with thicknesses in excess of the nanoscopic range on the annular flanks have an advantageous effect. The raised portions easily slide on the annular flanks positioned opposite one another, so that the rate of wear at the annular flanks is minimized, with the service life being prolonged.

According to one embodiment of the invention, the raised portions are provided in the form of burls.

The burls can have the shape of a spherical portion and comprise a height of approximately 0.05 to 1.3 mm above the uniform annular face of the annular flank. In the base region, the burls can comprise a diameter of approximately 3 mm. According to an alternative embodiment, the raised portions, in a cross-sectional view, can be lenticular in shape. The raised lenticular portions can be aligned either in the radial direction or in the circumferential direction.

According to a further embodiment, the raised portions can be uniformly circumferentially distributed. More particularly, they can be arranged on a plurality of coaxial circles on the annular flank. In one embodiment, there are provided 20 to 120, more particularly 60 to 80 raised portions on each circle, with the raised portions preferably being arranged at a maximum distance of 10 mm from one another. The number of raised portions on one annular flank depends on the size of the surface of the annular flank. In the case of annular flanks with several circles of raised portions, the raised portions on a first circle can be arranged so as to be circumferentially offset relative to the raised portions on an adjoining coaxial second circle. In this way, it is possible to achieve a uniform distribution of the raised portions on the surface of the annular flank.

According to another embodiment, in at least one annular fold, both annular flanks are provided with raised portions, wherein the raised portions of two opposed annular flanks are arranged so as to be radially and/or circumferentially offset relative to one another. In this way, it is ensured that the raised portions of two opposed annular flanks do not contact one another when the joint is articulated, so that all burls come into contact with the opposed annular face, with burl abrasion being avoided. According to a further embodiment, the raised portions of two opposed annular flanks are positioned on different radii.

A second solution provides a convoluted boot comprising an elastic material, which serves to seal an annular chamber filled with a lubricant between an outer joint part and a shaft connected to an inner joint part of a universal joint. The convoluted boot comprises a first collar to be fixed to the shaft and a second collar to be fixed to an outer part of a universal joint as well as a boot portion with a plurality of annular folds. Each of the annular folds comprises a first annular flank facing the first collar and a second annular flank facing the second collar, wherein the surfaces of at least one of the two annular flanks of at least one of the annular folds comprises a plurality of recesses which are set back from a uniform annular face.

Such a convoluted boot is advantageous in that, more particularly under wet rainy conditions, the development of noise in the articulated joint is minimized. In the present convoluted boot, as a result of the recesses set back relative to the annular flanks, the opposed annular flanks of two adjoining annular folds do not rub against one another in a planar way when the universal joint rotates. A uniform annular face means a conical or convex or concave annular rotational face. In this way, the adhesion forces effective as a result of a water film between the annular flanks are reduced so that unpleasant noise is reduced. Furthermore, the lubricating characteristics of the water between the annular flanks are improved so that rate of wear at the annular flanks is minimized, with the service life of the convoluted boot being prolonged.

According to another embodiment of the invention, the recesses are provided in the form of indentations. The indentations can have the shape of a spherical portion and comprise a maximum depth of 1 mm relative to the uniform annular face of the annular flank. In the region of the annular face, the indentations can comprise a diameter of approximately 3 mm.

According to a further embodiment of the invention, the recesses are uniformly distributed across the circumference. More particularly, they can be arranged on several coaxial circles on the annular flank. In one embodiment, 20 to 120, more particularly 60 to 80 recesses are arranged on one circle, with the recesses preferably being arranged so as to directly adjoin one another. The number of recesses on one annular flank depends on the size of the surface of the annular flank. In the case of annular flanks with several circles of recesses, the recesses on a first circle are circumferentially offset relative to the recesses of the adjoining coaxial second circle. In this way, it is possible to achieve a uniform distribution of the recesses on the surface of the annular flanks.

Other advantages and features of the invention will also become apparent upon reading the following detailed description and appended claims, and upon reference to the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention.

FIG. 1 shows an inventive convoluted boot in a perspective view.

FIG. 2 shows the convoluted boot according to FIG. 1:

A) in a plan view; and

B) in a longitudinal section

FIG. 3 shows a detail X of FIG. 2B.

FIG. 4 shows part of an annular flank with an alternative embodiment of the raised portions in an axial view.

FIG. 5 shows part of an annular flank with a further embodiment of raised portions in an axial views.

FIG. 6 shows a second embodiment of an inventive convoluted boot in a perspective view.

FIG. 7 shows the convoluted boot according to FIG. 6:

A) an a plan view; and

B) in a longitudinal section

FIG. 8 shows the detail Y of FIG. 7B.

### DETAILED DESCRIPTION OF THE DRAWINGS

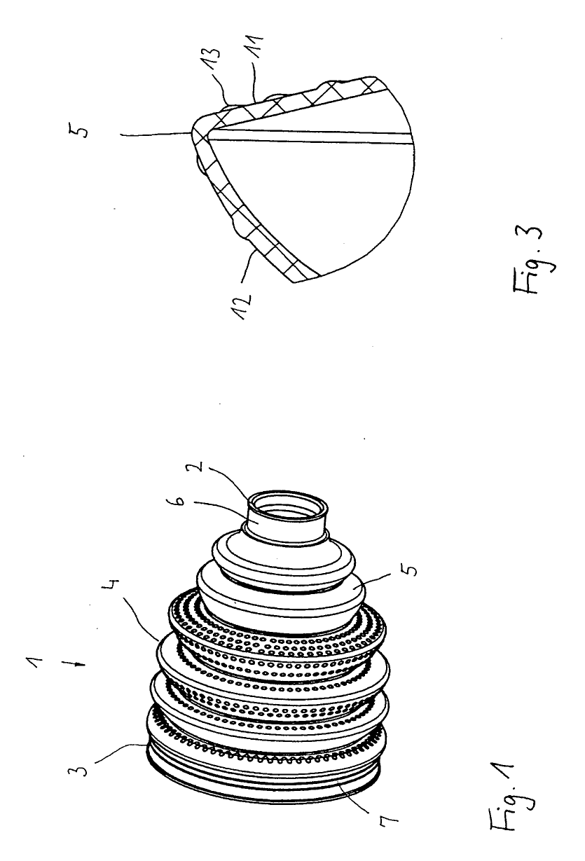

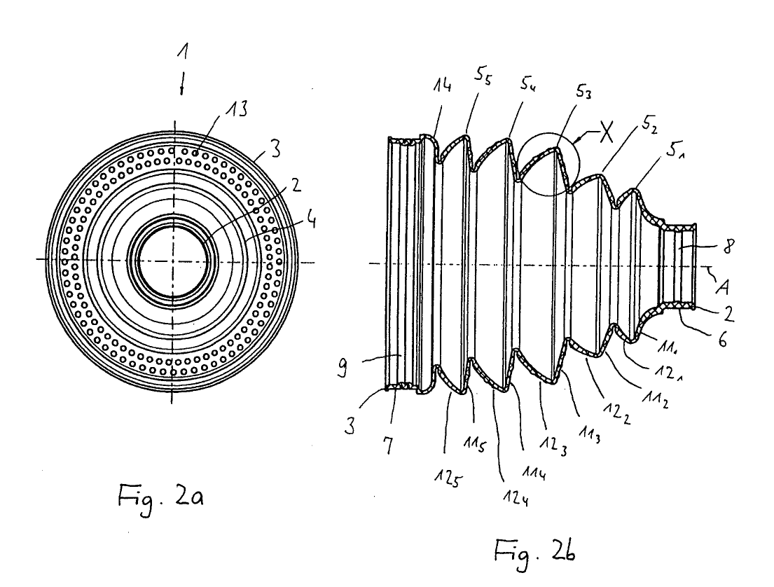

FIGS. 1 to 3 will be described jointly. Thus, corresponding details have been given the same reference numbers. FIG. 1 to 3 show a convoluted boot made of an elastic material which is used for sealing an annular chamber filled with lubricant between an outer joint part of a universal joint and a shaft connected to the inner joint part of a universal joint, with the universal joint and the shaft not being illustrated in the drawings.

The convoluted boot 1 comprises a first collar 2 for being fixed to a shaft, a second collar 3 for being slipped on to the outer joint part, as well as a boot portion which connects the two collars and comprises five annular folds 5 with different radii. On its radial outside, the first collar 2 comprises a continuous annular groove 6 for receiving a tensioning strip, and on its radial inside, it comprises a continuous annular bead 8 for engaging a corresponding annular groove in the shaft. The second collar 3, too, on its radial outside, comprises a continuous groove 7 which can be engaged by a tensioning strip (not shown in detail), and, on its radial inside, it includes two continuous annular beads 9 which can sealingly engage corresponding annular grooves in the outer face of the outer joint part. The annular beads 6, 8 ensure that the collars 2, 3 are axially fixed to their associated component. Other sealing arrangements are also contemplated. Likewise, the number of annular folds can also vary.

The annular folds 5 one of which is shown in detail in FIG. 3 comprise a first annular flank 11 pointing towards the first collar 2, and a second flank 12 pointing towards the second collar 3. In order to avoid two opposed annular flanks 11, 12 from having planar contact when the universal joint is articulated, the annular folds 5 comprise burls 13 which project from the uniform annular face of the annular flank. The burls 13 have the shape of a spherical portion; they comprise a height of approximately 0.3 mm starting from the uniform annular face of the annular flank and a diameter of approximately 3 mm in the base region.

Counting from the first collar 2 towards the second collar 3, the first and second annular folds 5₁, 5₂ do not include burls 13 because the annular faces 11₂, 12₁ facing one another do not come into contact with one another when the universal joint is articulated. Of course, they could include burls if they wee likely to be contacting each other during joint operation. Both annular faces 11₃, 12₃ of the third annular flank 5₃ comprise burls 13, with the annular face 11₃ pointing towards the first collar 2 comprising three coaxial circular rings with burls 13. When the convoluted boot 1 is articulated, the annular faces 12₂ of the second annular fold 5₂ and the annular face 11₃ of the third annular fold 5_{3 are} held at a distance from one another, so that they do not rub against each other and thus, more particularly under wet rainy conditions, do not generate any undesirable noise.

Even in pairs of annular faces 11₄, 12₃ between the third and the fourth annular fold 5₃, 5₄ and the annular faces 11₅, 12₄ between the fourth and the fifth annular fold 5₄, 5₅, there is provided a total of three coaxial circular rings with burls 13 which hold the respective surfaces at a distance from one another. The different circular rings with burls 13 have different radii, thus preventing the burls of two opposed annular flanks from contacting one another, which would lead to abrasion and wear. On a connecting annular fold 14 positioned opposite the second annular flank 12₅ of the fifth annular fold 5₅, there are provided two circular rings of burls 13 which hold the respective opposed uniform annular faces at a distance from one another when the joint is articulated. In this way, planar friction is avoided in this case, too.

Depending on the size of the annular flanks coming into contact with one another, the number of circular rings with burls is designed in such a way that the burls of one circular ring are arranged at a distance of 2 to 5 mm from one another. This approximately corresponds to a number of 20 to 120, more particularly 60 to 80 burls, per circular ring.

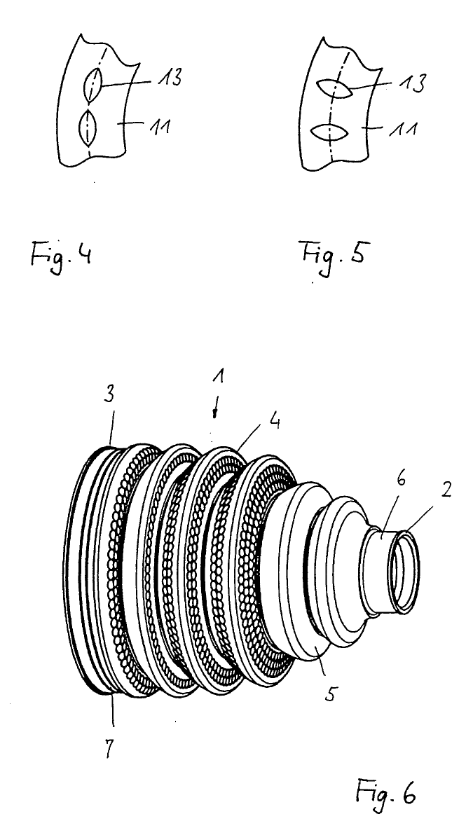

FIGS. 4 and 5 show alternative embodiments of raised portions which, instead of being burls in the shape of spherical portions, have a semi-lenticular shape. The raised lenticular portions can either extend in the circumferential direction as shown in FIG. 4, or in the radial direction, as shown in FIG. 5. The raised lenticular portions can also be arranged on coaxial circles. To that extent, reference is made to the above description.

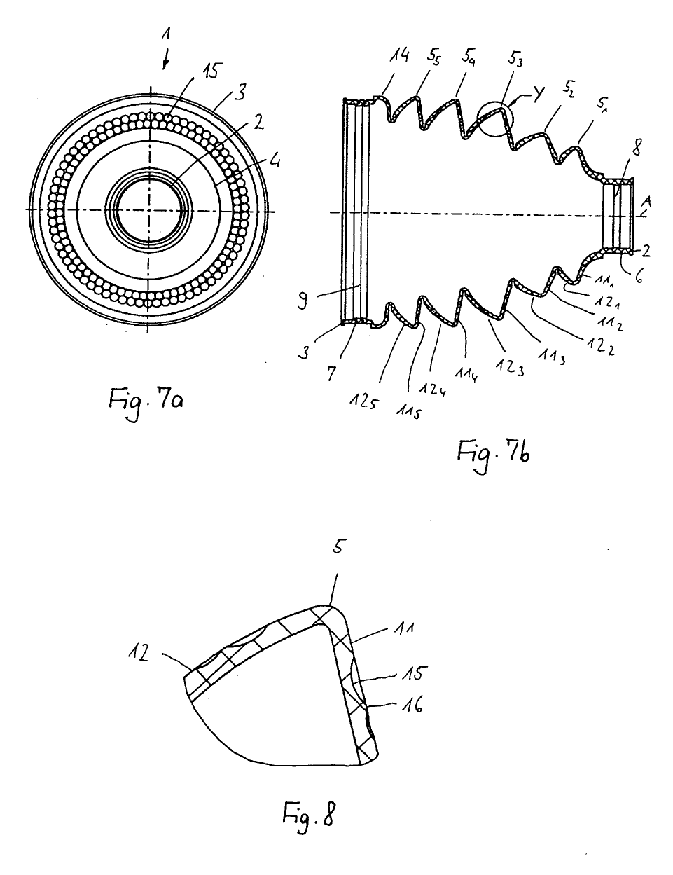

FIGS. 6 to 8 which will be described jointly below show a second embodiment of an inventive convoluted boot.

As far as design is concerned, this embodiment substantially corresponds to the convoluted boot according to FIGS. 1 to 3 to the description of which reference is hereby made. Identical components have been given the same reference numbers. In contrast to embodiments with raised portions, the convoluted boot according to FIGS. 6 to 8 comprises recesses which are set back from a uniform annular face. The recesses are provided in the form of indentations 15 which directly adjoin one another and are arranged on circles extending coaxially around the longitudinal axis A. Depending on the size of the annular faces of the annular flanks, there are provided one to three circles with indentations 15, with the indentations 15 of the first circle being circumferentially offset relative to the indentations 15 of the second circle extending coaxially relative thereto. The indentations 15 set back relative to the annular flanks ensure that the annular flanks 11, 12 do not rub against each other in a planar way, because the contact at the raised portions 16 formed between the indentations 15 is of a irregular nature. The development of noise, more particularly under wet rainy conditions, is thus minimized when the joint is in an articulated condition.

While the invention has been described in connection with several embodiments, it should be understood that the invention is not limited to those embodiments. For example, a combination of indentations 15 and burls 13 could be used in a single convoluted boot. In such a case, the annular flanks facing each other would comprise the same noise reducing feature whether indentations 15 or burls 13. Thus, the invention covers all alternatives, modifications, and equivalents as may be included in the spirit and scope of the appended claims.

What is claimed is:

1. A convoluted boot made of an elastic material, and having a longitudinal axis (A), the boot sealing an annular chamber between an outer joint part and a shaft connected to an inner joint part of a universal joint and comprising:
a first collar (2) to be fixed to the shaft and a second collar (3) to be fixed to an outer part of the universal joint as well as a boot portion (4) with a plurality of annular folds (5), which boot portion (4) connects the two collars, wherein each of the annular folds (5) comprises a first annular flank (11) facing the first collar (2) and a second annular flank (12) facing the second collar (3), wherein the surface of at least one of the two annular flanks (11, 12) of at least one of the annular folds (5) comprises a plurality of raised portions which project from a uniform annular face.

2. A convoluted boot according to claim 1, wherein the raised portions comprise burls (13).

3. A convoluted boot according to claim 2, wherein the burls (13) are partially spherically shaped.

4. A convoluted boot according to claim 2, wherein the burls (13) comprise a height of approximately 0.05 to 1.3 mm above the uniform annular face.

5. A convoluted boot according to claim 4, wherein, at their base, the burls (13) comprise a diameter of approximately 3 mm.

6. A convoluted boot according to claim 1, wherein the raised portions, in a cross-sectional view, are semi-lenticular in shape.

7. A convoluted boot according to claim 1, wherein, on the at least one annular flank (11, 12), the raised portions are uniformly distributed on at least one circle extending coaxially relative to the longitudinal axis (A).

8. A convoluted boot according to claim 7, wherein 20 to 120 raised portions are arranged on one circle.

9. A convoluted boot according to claim 7, wherein the raised portions of one circle are arranged at a maximum distance of 10 mm from one another.

10. A convoluted boot according to claim 1, characterised in that at at least one annular fold (5), both annular flanks (11, 12) are provided with raised portions, and wherein the raised portions (13) of two opposed annular flanks (11, 12) are arranged so as to be radially or circumferentially offset relative to one another.

11. A convoluted boot according to claim 10, wherein, at two adjoining annular folds (5), the raised portions of the two opposed annular flanks (11, 12) are positioned on circles with different radii.

12. A convoluted boot according to claim 7, wherein the raised portions on a first circle are arranged so as to be circumferentially offset from the raised portions on a second circle extending coaxially relative to said first circle.

13. A convoluted boot according to claim 7, wherein two adjoining circles are arranged at a maximum radial distance of 10 mm relative to one another.

14. A convoluted boot made of an elastic material, and having a longitudinal axis (A), the boot sealing an annular chamber between an outer joint part and a shaft connected to an inner joint part of a universal joint and comprising:
a first collar (2) to be fixed to the shaft and a second collar (3) to be fixed to an outer part of the universal joint as well as a boot portion (4) with a plurality of annular folds (5), which boot portion (4) connects the two collars, wherein each of the annular folds (5) comprises a first annular flank (11) facing the first collar (2) and a second annular flank (12) facing the second collar (3), wherein the surface of at least one of the two annular flanks (11, 12) of at least one of the annular folds (5) comprises a plurality of recesses which are set back from a uniform annular face.

15. A convoluted boot according to claim 14, wherein the recesses comprise indentations (15).

16. A convoluted boot according to claim 15, wherein the indentations (15) are partially spherically shaped.

17. A convoluted boot according to claim 14, wherein, on the at least one annular flank (11, 12), the recesses are uniformly distributed on at least one circle extending coaxially relative to the longitudinal axis (A).

18. A convoluted boot according to claim 17, wherein 20 to 120 recesses are arranged on one circle.

19. A convoluted boot according to claim 14, wherein the recesses are arranged to directly adjoin one another.

20. A convoluted boot according to claim 17, wherein the recesses on one circle are arranged so as to be circumferentially offset relative to the recesses on a second circle extending coaxially relative to said first circle.
